(19) United States
(12) Patent Application Publication
(10) Pub. No.: US 2018/0188370 A1
(43) Pub. Date: Jul. 5, 2018

(54) COMPACT DISTANCE MEASURING DEVICE USING LASER

(71) Applicant: HON HAI PRECISION INDUSTRY CO., LTD., New Taipei (TW)

(72) Inventor: PO-YU LIN, New Taipei (TW)

(21) Appl. No.: 15/599,542

(22) Filed: May 19, 2017

(30) Foreign Application Priority Data
Dec. 29, 2016 (TW) 105143858

(51) Int. Cl. G01S 17/08; G01S 7/481

(52) U.S. Cl. CPC G01S 17/08; G01S 7/4813

(57) ABSTRACT

A small size laser distance measuring device which measures a distance to an object includes a laser emission module, a collimating lens, a first micro electromechanical system, a second micro electromechanical system, a focusing lens, and a laser receiving module. The first micro electromechanical system and the second micro electromechanical system are rotatable. The laser distance measuring device has small volume and large field of view.

### FIELD

The subject matter herein generally relates to a laser distance measuring device.

### BACKGROUND

Laser distance measuring device has been widely used for measuring distance between an object and the device. Nowadays device with a small volume are preferred, thereby a laser distance measuring device with a small volume is needed.

### BRIEF DESCRIPTION OF THE DRAWING

Implementations of the present technology will now be described, by way of example only, with reference to the attached figure.

FIG. 1 is a diagram of a laser distance measuring device according to an exemplary embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts may be exaggerated to illustrate details and features of the present disclosure better.

Several definitions that apply throughout this disclosure will now be presented.

The term “comprising” when utilized, means “including, but not necessarily limited to”; it specifically indicates open-ended inclusion or membership in the so-described combination, group, series, and the like. The term “about” when utilized, means “not only includes the numerical value, but also includes numbers closest to the numerical value”.

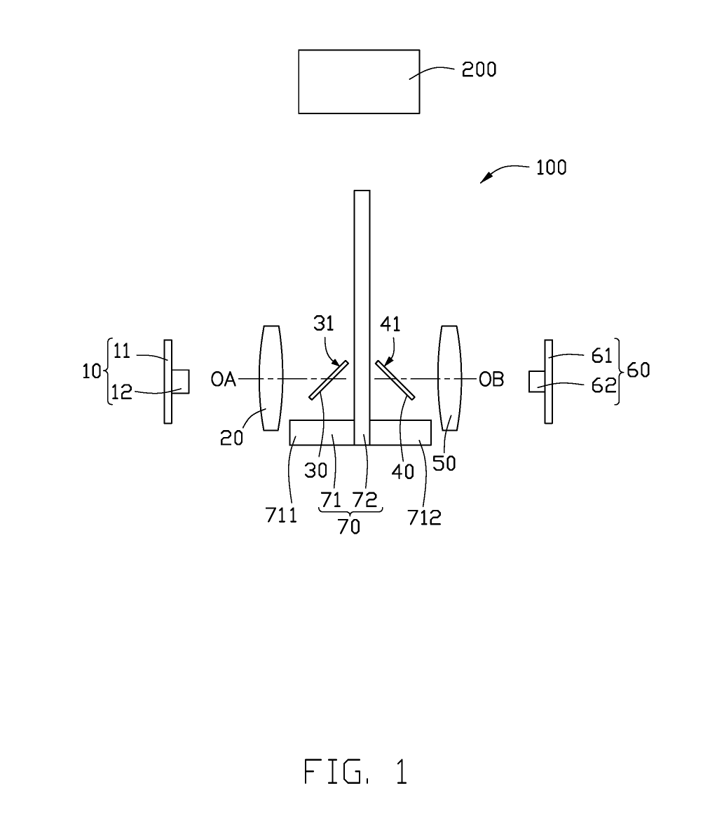

FIG. 1 illustrates an exemplary embodiment of a laser distance measuring device 100. The laser distance measuring device 100 is configured to measure a distance between the laser distance measuring device 100 and an object 200. The laser distance measuring device 100 includes a laser emission module 10, a collimating lens 20 facing towards the laser emission module 10, a first micro electromechanical system (MEMS) 30 rotatably located at a side of the collimating lens 20 away from the laser emission module 10, a second MEMS 40, a focusing lens 50 facing towards the second MEMS 40, and a laser receiving module 60 facing towards the second MEMS 40. The second MEMS 40 is rotatably located at a side of the focusing lens 50 away from the laser receiving module 60. The first MEMS 30 and the second MEMS 40 face towards the object 200.

In at least one exemplary embodiment, the laser emission module 10, the collimating lens 20, the first MEMS 30, the second MEMS 40, the focusing lens 50, and the laser receiving module 60 are arranged in that order from left side to right side of the laser distance measuring device 100. In other exemplary embodiment, the laser emission module 10, the collimating lens 20, the first MEMS 30, the second MEMS 40, the focusing lens 50, and the laser receiving module 60 are arranged in that order from right side to left side of the laser distance measuring device 100.

A light propagation path of the laser distance measuring device 100 is that lasers are emitted out from the laser emission module 10, pass through the collimating lens 20, irradiate on the first MEMS 30 and are refracted by the first MEMS 30. The lasers then irradiate the object 200 and are reflected by the object 200, irradiate on the second MEMS 40 and are refracted by the second MEMS 40, then pass through the focusing lens 50, and finally are received by the laser receiving module 60.

The laser emission module 10 is configured to emit lasers. The laser emission module 10 includes a first substrate 11, and at least one laser diode 12 secured to a surface of the first substrate 11. The laser diode 12 is configured to emit pulsed lasers. The first substrate 11 is a circuit board.

The collimating lens 20 has a first optical axis OA. The laser emission module 10 and the first MEMS 30 are located on the first optical axis OA. The collimating lens 20 faces towards the laser diode 12 and is located between the laser emission module 10 and the first MEMS 30. The collimating lens 20 is configured to focus the laser beams coming from the laser emission module 10 to direct more lasers to the first MEMS 30.

The collimating lens 20 may be a biconvex lens, or a plano-convex lens. The collimating lens 20 may be made of glass or resin.

The first MEMS 30 includes a first reflecting surface 31 facing towards the collimating lens 20. An angle between the first reflecting surface 31 and the first optical axis OA is greater than 0 degree and less than 90 degrees. The first reflecting surface 31 includes a two-dimensional scanning reflection array (not shown). The first MEMS 30 can drive the first reflecting surface 31 to rotate, thereby a position of the first reflecting surface 31 can be changed, to direct more lasers to the first reflecting surface 31. More lasers can thus be refracted to the object 200 by the first reflecting surface 31. The rotating of the first reflecting surface 31 can also increase a laser irradiating range of the laser distance measuring device 100, thereby increasing a measuring range of the laser distance measuring device 100. In other words, a field of view (FOV) of the laser distance measuring device 100 is increased.

In at least one exemplary embodiment, the first MEMS 30 includes a micro motor (not shown), the micro motor is configured to drive the first MEMS 30 to rotate.

The second MEMS 40 includes a second reflecting surface 41 facing towards the focusing lens 50. The second reflecting surface 41 and the first reflecting surface 31 are facing away from each other. The second reflecting surface 41 includes a two-dimensional scanning reflection array (not shown). The orientation of the second reflecting surface 41 can be changed, thereby a position of the second reflecting surface 41 can be changed, to ensure more lasers are reflected by the object 200 to irradiate to the second reflecting surface 41, and ensuring that more laser beams are refracted to the focusing lens 50. The rotating of the second reflecting surface 41 can also increase an laser receiving range of the laser distance measuring device 100, thereby increasing a measuring range of the laser distance measuring device 100. In other words, an FOV of the laser distance measuring device 100 is increased.

In at least one exemplary embodiment, the second MEMS 40 includes a micro motor (not shown), the micro motor is configured to drive the second MEMS 40 to rotate.

The focusing lens 50 has a second optical axis OB. An angle between the second reflecting surface 41 and the second optical axis OB is greater than 0 degree and less than 90 degrees. The second MEMS 40 and the laser receiving module 60 are located on the second optical axis OB. The focusing lens 50 is located between the second MEMS 40 and the laser receiving module 60. The focusing lens 50 is configured to focus the lasers refracted by the MEMS 40 to ensure that more lasers can irradiate to the laser receiving module 60.

The focusing lens 50 may be a biconvex lens, or a plano-convex lens. The focusing lens 50 may be made of glass or resin.

The laser receiving module 60 is configured to receive lasers. The laser receiving module 60 includes a second substrate 61, and at least one photo diode 62 secured to a surface of the second substrate 61. The at least one photo diode 62 faces towards the focusing lens 50. The photo diode 62 is configured to receive reflected lasers. The second substrate 61 is a circuit board.

The laser distance measuring device 100 comprises the first MEMS 30 and the second MEMS 40, the first MEMS 30 and the second MEMS 40 are rotatable and can refract lasers. The first MEMS 30 and the second MEMS 40 both have small volume, thereby the laser distance measuring device 100 has small volume.

The laser distance measuring device 100 further includes a signal processing module (not shown). The signal processing module is electrically connected with the laser emission module 10 and the laser receiving module 60. The signal processing module can record the process of the laser emission module 10 emitting laser and the process of the laser receiving module 60 receiving laser, thereby a total time of flight (TOF) t of the laser from the laser emission module 10 to the laser receiving module 60 is known, and a distance L between the laser distance measuring device 100 and the object 200 is calculated by a formula: L=ct/2, where c represents the speed of light.

The laser distance measuring device 100 further includes a distance piece 70. The distance piece 70 includes a mounting plate 71 and a spacer plate 72. The mounting plate 71 includes a first area 711 and a second area 712. An end of spacer plate 72 is located between the first area 711 and the second area 712 to separate the first area 711 and the second area 712. The first MEMS 30 is secured on the first area 711, the second MEMS 40 is secured on the second area 712, thereby the first MEMS 30 and the second MEMS 40 are separated by the spacer plate 72, thereby lasers emitted from the laser emission module 10, lasers through the collimating lens 20, or lasers refracted by the first MEMS 30 cannot reach the laser receiving module 60 directly.

When the laser distance measuring device 100 is used to measure a distance between the object 200 and the laser distance measuring device 100, the first MEMS 30 and the second MEMS 40 face towards the object 200, and then the laser distance measuring device 100 begins to measure. The laser diode 12 of laser emission module 10 emits a plurality of lasers. The lasers enter the collimating lens 20, and are focused by the collimating lens 20, and then exit from the collimating lens 20. The first MEMS 30 reflects the lasers exiting from the collimating lens 20 to the object 200. The object 200 reflects the lasers to the second MEMS 40 and the second MEMS 40 refracts the lasers to the focusing lens 50. The refracted lasers enter the focusing lens 50, is focused by the focusing lens 50, and then exits from the focusing lens 50. The lasers that exit from the focusing lens 50 are received by the photo diode 62 of the laser receiving module 60. The signal processing module records, measures, and calculates the distance L between the laser distance measuring device 100 and the object 200.

The embodiments shown and described above are only examples. Even though numerous characteristics and advantages of the present technology have been set forth in the foregoing description, together with details of the structures and function of the present disclosure, the disclosure is illustrative only, and changes can be made in the detail, including in matters of shape, size, and arrangement of the parts within the principles of the present disclosure, up to and including, the full extent established by the broad general meaning of the terms used in the claims.

What is claimed is:

1. A laser distance measuring device comprising:
a laser emission module;
a collimating lens facing towards the laser emission module;
a first micro electromechanical system rotatably at a side of the collimating lens away from the laser emission module, the first micro electromechanical system comprises a first reflecting surface;
a second micro electromechanical system comprising a second reflecting surface, the second reflecting surface and the first reflecting surface are facing away from each other;
a focusing lens facing towards the second reflecting surface; and
a laser receiving module at a side of the focusing lens away from the second micro electromechanical system;
wherein the second micro electromechanical system are rotatable, the laser emission module emits lasers, the collimating lens focuses the lasers, the first reflecting surface refracts the lasers to an object, the lasers refracted to the object can be reflected by the object, the second reflecting surface refracts the lasers reflected by the object to the focusing lens, the focusing lens focuses the lasers refract by the second reflecting surface, and the laser receiving module receives the lasers.

2. The laser distance measuring device of claim 1, wherein the laser emission module comprises a first substrate and at least one laser diode secured to a surface of the first substrate, the at least one laser diode faces towards the collimating lens, and the at least one laser diode emits pulsed lasers.

3. The laser distance measuring device of claim 1, wherein the collimating lens comprises a first optical axis, the laser emission module and the first micro electromechanical system are on the first optical axis, an angle between the first reflecting surface and the first optical axis is greater than 0 degree and less than 90 degrees.

4. The laser distance measuring device of claim 1, wherein the first reflecting surface comprises a two-dimensional scanning reflection array.

5. The laser distance measuring device of claim 1, wherein the second reflecting surface comprises a two-dimensional scanning reflection array.

6. The laser distance measuring device of claim 1, wherein the focusing lens comprises a second optical axis, the second micro electromechanical system and the laser receiving module are on the second optical axis, an angle between the second reflecting surface and the second optical axis is greater than 0 degree and less than 90 degrees.

7. The laser distance measuring device of claim 1, wherein the laser receiving module comprises a second substrate, and at least one photo diode secured to a surface of the second substrate, the at least one photo diode faces towards the focusing lens, and the photo diode receives lasers.

8. The laser distance measuring device of claim 1, wherein each of the collimating lens and the focusing lens is a biconvex lens or a plano-convex lens.

9. The laser distance measuring device of claim 1, wherein the laser distance measuring device further comprises a distance piece between the first micro electromechanical system and the second micro electromechanical system, the distance piece separates the first micro electromechanical system and the second micro electromechanical system.

10. The laser distance measuring device of claim 9, wherein the distance piece comprises a mounting plate and a spacer plate, the mounting plate comprises a first area and a second area, an end of spacer plate is between the first area and the second area to separate the first area and the second area, the first micro electromechanical system is mounted on the first area, and the second micro electromechanical system is mounted on the second area.
